(19) United States
(12) Patent Application Publication
(10) Pub. No.: US 2008/0095906 A1
(43) Pub. Date: Apr. 24, 2008

(54) Continuous thermal process for flavor preparation

(75) Inventors: Yan Zheng, Germantown, TN (US); Steve Williams, Cordova, TN (US); Andrew Bosch, Cordova, TN (US)

Correspondence Address: BROOKS KUSHMAN P.C., 1000 TOWN CENTER, TWENTY-SECOND FLOOR, SOUTHFIELD, MI, 48075, US

(73) Assignee: Kraft Foods Holdings, Inc., Northfield, IL (US)

(21) Appl. No.: 11/584,099

(22) Filed: Oct. 20, 2006

(51) Int. Cl. A23L 1/22

(52) U.S. Cl. 426/533

(57) ABSTRACT

A flavor composition is formed by combining a first precursor composition with a second precursor composition to form a precursor flavor composition. The precursor flavor composition is then subjected to a sufficient temperature to cause one or both of the first and second precursor compositions to undergo at least a partial phase change to a gaseous material. Generally, the first and second precursor compositions are immiscible.

### BACKGROUND OF THE INVENTION

1. Field of the Invention

The present invention relates to processes for forming flavor compositions, and in particular, to processes for forming flavor compositions in a continuous manner.

2. Background Art

Most food products develop their flavor during cooking. Raw meat, for example, has a salty, bloody taste and very little flavor. The palatable meaty flavor is formed only during cooking. Common cooking techniques such as stir-frying, sauteing, roasting, baking and grilling are usually performed in an open cooking vessel where food and other ingredients including oil or fat are added and mixed together with heating. During cooking, reactions such as a Maillard reaction, lipid oxidation, hydrolysis and other interactions occur to produce the characteristic cooked flavor. However, the flavor generated in such a way typically does not have enough strength to be used as flavorings for other food preparation.

A number of prior art methodologies exist to generate stronger flavor for food application. For example, the flavor industry employs high pressure/temperature cooking to speed up flavor-forming reactions. Pressure-cooking is carried out in a closed system that limits the amount of air participation in the reaction. Limiting exposure to air alters the chemical reactions (i.e. lipid oxidation) and hence the flavor profile. However, many prior art methods are difficult to implement due to the problems in mixing immiscible phases together at the high pressures and temperature of the process. Some of these limitations are partially alleviated by utilizing multi-step processes U.S. Pat. No. 4,604,290 (the '290 patent). In accordance to the methods of the '290 patent, fat is oxidized and then used in further processing with protein/amino acid to produce flavor. Although the process of the '290 patent works reasonably well, multi-step processes exhibit a wide variation in operation control and product quality.

U.S. Pat. No. 4,571,342 (the '342 patent) discloses a continuous process for continuously producing a flavor composition. Flavor precursors were introduced into the process at one end of the processor. After an effective period of time in the presence of oxygen, product was collected at the other end of the processor. The processing, however, limited the feedstock to a single oil-based phase. Unfortunately, many desirable flavor ingredients are water-based and immiscible in hot oil.

Accordingly, there exists a need in the prior art for forming flavor compositions from mixtures of oil and water based components.

### SUMMARY OF THE INVENTION

The present invention solves one or more problems of the prior art by providing in at least one embodiment a method for preparing a flavor composition. The method of this embodiment comprises a step of combining a first precursor composition with a second precursor composition to form a precursor flavor composition. The precursor flavor composition is then subjected to a sufficient temperature for a sufficient time to cause one or both of the first and second precursor compositions to undergo at least a partial phase change to a gaseous material. The gaseous material is then cooled to produce a liquid flavorant. Advantageously, the steps can be performed in a continuous manner if so desired.

In another embodiment of the present invention, an apparatus for making the flavor composition set forth above is provided. The flavor composition forming apparatus includes a reaction chamber which receives first and second flavor precursors. The apparatus further includes a first inlet for introducing the first flavor precursor to the reaction chamber, and a second inlet for introducing a second flavor precursor into the reaction chamber. The flavorant-forming apparatus further includes a heater for increasing the temperature of the first and second flavor precursors while the first and second flavor precursors are resident in the reaction chamber to form a gaseous material from the first and second flavor precursors. The multiport design of the present embodiment allows for the flavorant-forming process to resemble the real life situation where both water-soluble ingredients and fat are used in the cooking. It also provides a processor where oxygen participation in the reaction can be controlled to either mimic the open vessel cooking such as stir-frying, sauteing, baking, roasting and grilling, or oxygen-limited cooking such as smoking, simmering, canning, etc.

### BRIEF DESCRIPTION OF THE DRAWINGS

FIG. 1 is a schematic diagram of a flavor composition-forming apparatus of an embodiment of the invention; and

FIG. 2 is a schematic diagram of a flavor composition-forming apparatus having a post reaction treatment component for separating the liquid flavor composition from gaseous byproducts.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refer to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

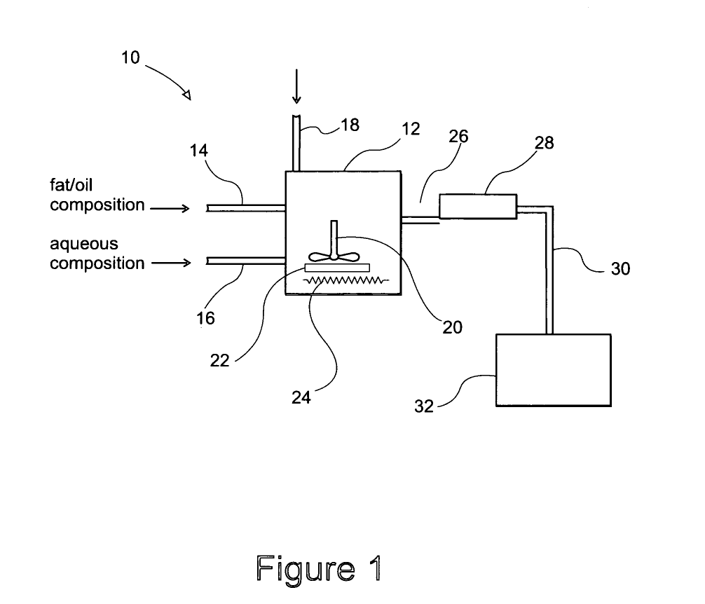

With reference to FIG. 1, a schematic illustration of an apparatus used to form a flavor composition is provided. Flavor-forming apparatus 10 includes reaction chamber 12. A first precursor composition and a second precursor composition are introduced into reaction chamber 12 and combined therein to form a precursor flavor composition. Alternatively, the first and second precursor compositions are premixed before introduction into reaction chamber 12. In a variation of the present embodiment, the first flavor precursor composition comprises a fat medium (i.e., fat or oil) while the second flavor precursor comprises an aqueous composition. The first precursor composition is introduced into reaction chamber 12 via first inlet conduit 14 while the second precursor composition is introduced into reaction chamber 12 via second conduit line 16. Optionally, additional reactants are introduced into reaction chamber 12 through conduit 18. In particular, an oxygen-containing gas such as air is provided through conduit 18 so that heating of the precursor flavor composition occurs in the presence of oxygen. In some variations of the present invention, the precursor flavor composition is reacted in the presence of oxygen. In other variations, the precursor flavor composition is reacted under oxygen lean conditions (less than a stoichiometric amount of oxygen) or in the substantial absence of oxygen. Characteristically, the first and second flavor compositions are at least partially immiscible with each other. In some variations, at least one component of the first precursor composition chemically reacts with at least one component of the second precursor composition. In other variations, at least one component of the first precursor composition or at least one component of the second precursor composition chemically reacts with oxygen when present. Mixer 20 is present in reaction chamber 12 to mix the first and a second precursor compositions together, and to spread the compositions out into film on plate 22 having increased surface area thereby promoting vaporization. While the first and second flavor compositions are resident within the reaction chamber 12, the precursor flavor composition is heated by heater 24 to a sufficient temperature for a sufficient time to cause one or both of the first and second precursor compositions to undergo at least a partial phase change to a gaseous material. In a variation, the precursor composition is heated to a temperature of at least 200° F. while present in reaction chamber 12. In another variation, the precursor composition is heated to a temperature from about 200° F. to about 400° F. while present in reaction chamber 12. In still another variation, the precursor composition is heated to a temperature less than about 800° F. while present in reaction chamber 12. In still another variation, the gaseous material reaches a temperature from 670° F. to 700° F. In still another variation, the precursor composition is heated to a temperature less than about 180° C. (356° F.) while present in reaction chamber 12 for a time period of 15 minutes or less, with corresponding longer times at lower temperatures. This latter variation is particularly useful when the precursor composition includes amino acids and reducing sugars. The resulting gaseous material is then transported via conduit 26 to cooler 28 to produce a liquid flavor composition which is subsequently transported via conduit 30 to post reaction processor 32 for further processing and collection. In some variations, the product liquid flavor composition is processed into a solid flavor composition. For example, the liquid flavor composition is further spray dried to form powder flavor. Advantageously, the process of the present embodiment may be run in a continuous manner for a predetermined period of time or until flavor-forming system 10 needs servicing.

In a variation of the present embodiment, the flavor precursor is distributed as a thin film while resident in reaction chamber 12. In such variations, reaction chamber 12 is a thin film evaporator that allows transition of the flavor precursor to the gaseous phase. Examples of useful thin film evaporators are the Rototherm® Thin Film Evaporator commercially available from Artison Industries, Inc. If necessary, these evaporators may be modified by closing off the vapor vent that would normally remove vapors while concentrating, and by replacing the heat exchange medium which is normally a heat transfer fluid with an electric resistance heater. A specific thin film evaporator is the Artison Rototherm® E which is a 1 square foot (heating surface) heat centrifugally-wiped exchanger. In a refinement of this variation, the thickness of this thin film has a thickness less than or equal to about 0.0625 inches. In other variations, the phase transition to a gaseous state is performed in a phase change by a falling film evaporator or a scraped surface heat exchanger. In another refinement of this variation, the thickness of the thin film is from about 0.0312 to about 0.0625 inches. The distribution of the flavor precursor composition into a thin film assists in vaporization. Both the first and second precursor compositions are at least partially vaporized while present in reactor 12. In a variation, the flavor precursor is resident in reaction chamber 12 for a period less than or equal to 20 minutes. In another variation, the flavor precursor is resident in reaction chamber 12 for a period less than or equal to 2 minutes. In yet another variation, the flavor precursor is present in reaction chamber 12 for a period of time less than about 90 seconds. In still another variation, the flavor precursor is resident in reaction chamber 12 for a period from about 15 to about 20 minutes. During this retention time, the fat phase and the aqueous phase will be elevated in temperature by the heat exchanger in the presence of air, the fat being charged in such a manner that the initial liquid phase exists in a very minor percent of the total time in the rototherm, typically less than 20 seconds. In one variaiton, the hot film will be rapidly vaporized with vaporization commencing at above 600° F. In another variation, the hot film is heated at a temperature of not more than 180° C. for 15 minutes or less. This latter variation is particularly useful when the film includes amino acids and reducing sugars.

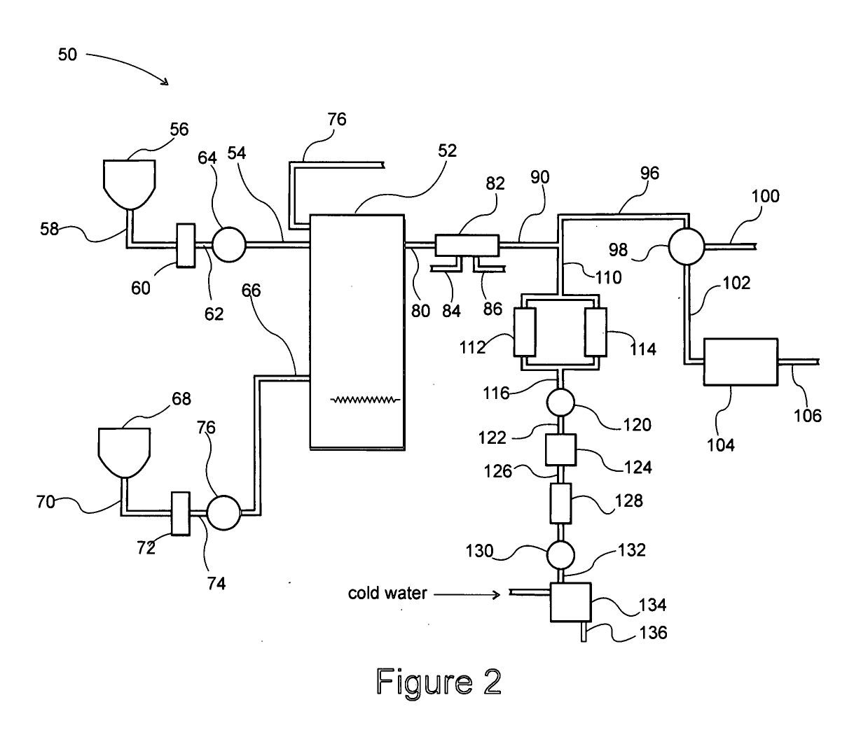

With reference to FIG. 2, a schematic illustration of another apparatus used to form a flavor composition is provided. Flavor-forming apparatus 50 includes thin film reactor 52. The first precursor composition and the second precursor composition are introduced into thin film reactor 52 and combined therein to form the precursor flavor composition. The first precursor composition is introduced into thin film reactor 52 via first inlet conduit 54. The first precursor composition is at least partially formed in first precursor reactor 56. Examples of useful reactors for first precursor reactor 56 include, but are not limited to, fat or oil tarrow reactors and/or open kettle reactors. Useable tallows include, but are not limited to, beef, kosher beef, chicken, lard, turkey and like flavoring fats and oils. Generally, the tallow is heated to a temperature such that it becomes fluid (usually exceeding 160° F.). The reaction product from tarrow reactor 56 is directed through conduit 58 to filter 60. Undesired materials and byproducts are removed by filter 60. The filtrate from filter 60 passes through conduit 62 to positive displacement feed pump 64 which pumps the reaction product into thin film reactor 52 via conduit 54. Similarly, the second precursor composition is introduced into thin film reactor 52 via conduit 66. The second precursor composition is at least partially formed in second precursor reactor 68. If necessary, the second precursor composition is heated while resident in reactor 68. The reaction product from second precursor reactor 68 is directed through conduit 70 to filter 72. Undesired materials and byproducts are removed by filter 72. The filtrate from filter 72 passes through conduit 74 to positive displacement feed pump 76 which pumps the reaction product into thin film reactor 52 via conduit 66. As set forth above, the precursor flavor composition is heated to undergo at least a partial phase change to a gaseous material. In a variation, the precursor composition is heated to a temperature of at least 600° F. while present in thin film reactor 52. Conduits 54, 58, 62, 66, 70, 74 are typically heated to prevent condensation or solidification. Usually heating to about 200° F. is sufficient for this purpose. Optionally, air is metered into thin film reactor 52 via conduit 76. Filtered compressed air may be used for this purpose. In a refinement of the present invention, thin film reactor 52 is maintained under a slight positive pressure not exceeding 15-20 psig.

Still referring to FIG. 2, the flavor composition formed in thin film reactor 52 is fed though conduit 80 to heat exchanger 82 which acts to cool the flavor composition. Cold water for cooling heat exchanger 82 enters through conduit 84 and exits through conduit 86. The flavor compositions emerges from heat exchanger 82 through conduit 90. Usually, the reactions of the flavor forming process are substantially completed by the time the flavor composition emerges from heat exchanger 82 with the flavor composition being in a liquid state. In one variation, the gaseous material reaches a maximum temperature of from 40° F. to 75° F. above the temperature of the heat exchanger 82. In another variation of the present embodiment, the temperature is in the range of from 100° F. to 130° F. upon emerging into conduit 90. A minor portion of the flavor reaction products may be still gaseous. These gaseous constituents are removed through vapor line 96. Typically, gaseous constituents make up about 10-20 wt % or less of the reaction product emerging from heat exchanger 82. At least a portion of this gaseous material which contains tarry and acrid notes is removed under a vacuum. In one refinement, the vacuum measures from 0.2 to 1.0 inches of mercury.

Still referring to FIG. 2, the vapor phase in line 96 passes a suitable vacuum pump 98, fresh air being drawn in at 100. Finally, the reaction byproducts pass through conduit 102 to thermal incinerator 104. Finally, the combustion products exit at 106. Advantageously, the temperature of heat exchanger 82 is adjusted to alter the ratio of liquid and gaseous products entering conduit 90. The higher the temperature at conduit 90 the greater the amount of spent vapor and consequently the lower percentage yield. At the aforesaid temperature range, an acceptable yield is obtained but yet a majority of off flavor notes are removed in the spent vapor. The liquid flavorant emerging from conduit 90 passes through conduit 110 and one of filters 112, 114 in a liquid state to remove carbonaceous particles. The filtered liquid fluid passes through conduit 116 until entering positive displacement pump 120. The liquid passes through conduit 122 to collection vessel 124. Optionally, the liquid flavorant is filtered again by passing through conduit 126 and filter 128. In some variations, the liquid flavorant is combined with an antioxidant in pump 130. The liquid flavorant is then moved from pump 130 through conduit 132 to mixer 134. While present in mixer 134, the liquid flavorant and the antioxidant are cooled and mixed. Finally, the product flavor composition is recovered at 136. Mixer 134 is operated so as to admit cold water to the jacket thereof, thus further cooling the flavor composition typically to a temperature of 100° F. or less. Advantageously, the process of the present embodiment may be run in a continuous manner for a predetermined period of time or until flavor-forming system 50 needs servicing. Continuous operation of 48 hours is typically achieved.

In at least some processes set forth above, the temperature of the precursor composition will eventually exceed the surface temperature of the heat exchanger itself. Thus, as indicated previously the minimum heat exchange surface temperature will be in excess of 200° F. measured at the heat exchanger surface and, in a relevantly brief period of time, the exothermic liberation of heat results in a temperature increase of the precursor compositions (generally about 50° F.) with regard to the temperature of the heating surface. A range of 40° F. to 75° F. above the temperature of the heat exchange surface being achieved in some cases.

As set forth above, in some variations the first precursor composition includes a fat medium. The fat medium comprises an animal fat, a dairy fat, vegetable fat, a lipolyzed fat, oil soluble materials, and combinations thereof. Suitable animal fats include beef fat, chicken fat or fish oil. The vegetable fat is typically a vegetable oil fatty ester shortening composition selected from vegetable oils including oleic acid oils, linolenic acid oils and erucic acid oils, such as cottonseed oil, peanut oil, sesame seed oil, corn oil, soybean oil, safflower oil, sunflower seed oil, rapeseed oil and other edible oilseed oils, and mixtures thereof. In addition, the term vegetable oil fatty ester shortening compositions as used herein includes oils such as polyol fatty acid esters including polyglycerol fatty acid esters and sugar fatty acid esters. Examples of dairy fats include butter, cream, and the like. The specific fat medium utilized will vary the character of the resultant meat flavoring composition. For example, oleic acid is preferred for achieving a strong beef-like character, while linoleic acid provides a roasted chicken or fish character.

As set forth above, the second precursor composition includes an aqueous composition. Suitable ingredients that may be present in the aqueous composition include, but are not limited to, amino acids, reducing sugars, and combinations thereof. The amino acids may be a single amino acid which is specifically associated with the desired meat flavoring composition, a mixture of various amino acids or a protein hydrolysate. Sulfur-containing amino acids such as cysteine, cystine, methionine, glutathione, 2-amino-ethane sulfonic acid or their salts, and the like, are particularly useful. Specific examples of useful amino acids include, but are not limited to, L-cysteine, L-proline, L-methionine, serine, leucine, isoleucine, lysine, and combinations therof. The reducing sugar may be a mono-, di-, or oligo-saccharide, such as xylose, fructose, etc. Specific examples of useful reducing sugars include, but are not limited to, D-xylose, D-ribose, fructose, D-glucose, and combinations thereof.

The first and second precursor composition can each independently include additional flavoring components. Examples of such additional flavoring components include, but are not limited to, soy sauce, salt, pepper, and combinations thereof. Moreover, the first and second precursor compositions optionally include other additives such as thiamine HCl, ascorbic acid, onion juice abstract, garlic juice extract, and combinations thereof.

The following examples illustrate the various embodiments of the present invention. Those skilled in the art will recognize many variations that are within the spirit of the present invention and scope of the claims.

### EXAMPLE 1

An aqueous reactant solution is prepared by dissolving L-cysteine and D-xylose in diluted liquid soy sauce at the following percentages: 4.5% L-cysteine, 6.7% D-xylose, 22.2% liquid soy sauce, and 66.6% water. A modified thin film evaporator is heated to about 300° F. A stream of sunflower oil is introduced into the thin film evaporator at 30 lb/hr while the aqueous solution prepared above is introduced into the processor at 5.3 lb/hr. The ratio of the oil/aqueous solution is kept at 85/15. The mixture is mixed vigorously with a scrap surface mixer at a speed of at least 300 rpm to form a film on the inner surface of the thin film evaporator. The mixture is reacted for about 2 minutes before exiting the thin film evaporator. The liquid flavor is then cooled through a serial of jacketed cooling tubes to 160° F. Sensory evaluation of 0.25% of the flavor in 0.5% salt solution reveals that the flavor has a good balance of savory, chicken and slightly roasted sesame characteristics.

### EXAMPLE 2

A stream of vegetable oil is introduced into a modified thin film evaporator at 35 lb/hr and heated to about 680° F. for 20 sec to 1 minute with or without the addition of air. The liquid is then cooled to 200° F. The resultant oil possesses fatty, charbroil flavor characteristics.

### EXAMPLE 3

A stream of aqueous flavor precursor system is fed into a modified thin film evaporator at 21 lb/hr. With the mixer running at 300 rpm, the precursor system is heated to 250° F. for about 2 minutes. The mixture consists of L-proline 5.10% L-cysteine 1.19% L-methionine 0.34% D-ribose 1.19% Glycerol 15.00% Water 77.18%, After the process, the resultant mixture is then cooled to 160° F. and collected. The resultant product has a strong beefy, brothy and vegetable flavor characteristic.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for preparing a flavor composition, the method comprising:
a) combining a first precursor composition with a second precursor composition to form a precursor flavor composition;
b) subjecting the precursor flavor composition to a sufficient temperature for a sufficient time to cause one or both of the first and second precursor compositions to undergo at least a partial phase change to a gaseous material; and
c) cooling the gaseous material to produce a liquid flavorant.

2. The method of claim 1 wherein the first and second precursor compositions are at least partially immiscible with each other.

3. The method of claim 1 wherein step a), b) and c) are performed in a substantially continuous manner for a predetermined period of time.

4. The method of claim 1 wherein the sufficient temperature of step b) is at least 200° F.

5. The method of claim 4 wherein step b) is performed in the presence of oxygen.

6. The method of claim 4 wherein step b) is performed under oxygen lean conditions.

7. The method of claim 4 wherein in step b) the phase change is within a thin film heat exchanger, a falling film evaporator, or a scraped surface heat exchanger.

8. The method of claim 4 wherein the gaseous material reaches a maximum temperature of from 40° F. to 75° F. above the temperature of the heat exchanger.

9. The method of claim 1 wherein the sufficient temperature of step b) is such that at least one component of the first precursor composition chemically reacts with at least one component of the second precursor composition.

10. The method of claim 9 wherein step b) the phase change is performed by a thin film heat exchanger, a falling film evaporator, or a scraped surface heat exchanger.

11. The method of claim 9 wherein the duration of step b) is less than or equal to 20 minutes.

12. The method of claim 1 wherein the first precursor composition comprises oil or fat.

13. The method of claim 12 wherein the second precursor composition is an aqueous composition.

14. The method of claim 13 wherein the aqueous composition comprises a component selected from the group consisting of amino acids, reducing sugars, and combinations thereof; and the first precursor composition comprises vegetable oil, animal fats, dairy fats, lipolyzed fats, oil soluble materials, and combinations thereof.

15. The method of claim 14 wherein the amino acids include a component selected L-cysteine, L-proline, L-methionine, serine, leucine, isoleucine lysine, and combinations thereof; and the reducing sugars include a component selected from the group consisting of D-xylose, D-ribose, fructose, D-glucose, and combinations thereof.

16. The method of claim 15 wherein the first precursor composition and the second precursor composition each independently include one or more additional flavoring components.

17. The method of claim 16 wherein the one or more additional flavoring components include a component selected from the group consisting of soy sauce, salt, pepper, yeast extract, food extracts, and combinations thereof.

18. The method of claim 1 wherein the gaseous material is cooled in step c) to a temperature range of 100° F. to 130° F.

19. The method of claim 1 wherein a portion of the gaseous material containing tarry and acrid notes is removed under a vacuum.

20. The method of claim 19 wherein the vacuum measures from 0.2 to 1.0 inches of mercury.

21. The method of claim 1 wherein the time in step b) is 90 seconds or less.

22. The method of claim 1 wherein the gaseous material in step b) is heated to a temperature less than 800° F.

23. The method of claim 1 wherein the gaseous material in step b) is heated to a temperature from 670° F. to 700° F.

24. The method of claim 1 wherein the gaseous material in step b) is heated to a temperature of less than 180° C.

25. The method of claim 1 further comprising drying the liquid to form a solid flavorant.

26. A method for preparing a flavor composition, the method comprising:
a) combining a first precursor composition with a second precursor composition to form a precursor flavor composition, the first and second precursor compositions being optionally at least partially immiscible with each other;
b) subjecting the precursor flavor composition to a sufficient temperature for a sufficient time to cause one or both of the first and second precursor compositions to undergo at least a partial phase change to a gaseous material; and
c) cooling the gaseous material to produce a liquid flavorant, wherein step a), b) and c) are performed in a substantially continuous manner for a predetermined period of time.

27. The method of claim 26 wherein the sufficient temperature of step b) is at least 200° F.

28. The method of claim 26 wherein step b) is performed in the presence of oxygen or under oxygen lean conditions.

29. The method of claim 26 wherein the first precursor composition comprises oil or fat.

30. The method of claim 29 wherein the second precursor composition is an aqueous composition.

31. The method of claim 30 wherein the aqueous composition comprises a component selected from the group consisting of amino acids, reducing sugars, and combinations thereof, and the first precursor composition comprises vegetable oil.

32. The method of claim 26 wherein the gaseous material is cooled in step c) to a temperature range of 100° F. to 130° F.

33. The method of claim 26 wherein the gaseous material in step b) is heated to a temperature less than about 800° F.

34. The method of claim 26 further comprising drying the liquid to form a solid flavorant.

35. An apparatus for making a flavor composition, the apparatus:
a first inlet for introducing a first flavor precursor into the apparatus;
a second inlet for introducing a second flavor precursor into the apparatus;
a reaction chamber which receives the first and second flavor precursors from the first and second inlets and in which the first and second flavor precursors are combined; and
a heater for increasing the temperature of the first and second flavor precursors while the first and second flavor precursors are resident in the reaction chamber to form a gaseous material from the first and second flavor precursors.

36. The apparatus of claim 32 further comprising a cooling system for reducing the temperature of the gaseous material or a condensate formed from the gaseous material.

37. The apparatus of claim 32 further comprising a mixer for mixing the first and second flavor precursors while the first and second flavor precursors are resident in the reaction chamber.

38. The apparatus of claim 32 further comprising one or more additional inlets for introducing one or more additional flavor precursors.
